(19) United States
(12) Patent Application Publication
(10) Pub. No.: US 2007/0041172 A1
(43) Pub. Date: Feb. 22, 2007

(54) Backlight assembly and display device having the same

(75) Inventors: Joon-Gon Son, Chungcheongnam-do (KR); Dong-Lyoul Shin, Suwon-si (KR); Jheen-Hyeok Park, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/506,391

(22) Filed: Aug. 18, 2006

(30) Foreign Application Priority Data
Aug. 19, 2005 (KR) 2005-75993

(51) Int. Cl. G09F 13/04

(52) U.S. Cl. 362/97

(57) ABSTRACT

A backlight assembly for a display includes a microwave generating member, a light-generating member and a light-guiding member. The microwave generating member generates a microwave and light-generating member generates light by using the microwave. Light-guiding member is connected to light-generating member to guide light generated from light-generating member. The backlight assembly generates light by using a microwave instead of an electrode and a fluorescent material so that the display device may have enhanced luminance uniformity and stability.

### CROSS-REFERENCE TO RELATED APPLICATIONS

This application claims priority under 35 U.S.C. § 119 to Korean Patent Application No. 2005-75993, filed on Aug. 19, 2005, the contents of which is hereby incorporated by reference.

### FIELD OF THE INVENTION

This invention relates to a backlight assembly having an improved image display quality and a display device having the backlight assembly.

### DESCRIPTION OF THE RELATED ART

In general, a liquid crystal display (LCD) apparatus displays an image by utilizing electrical and optical characteristics of liquid crystal. The LCD displays an image using light transmittance of the liquid crystal and a backlight assembly that provides the LCD with light. The backlight assembly is classified as either an edge type or a direct illumination type backlight according to the position of light source.

The edge type backlight assembly includes one or two lamps positioned at the side of a transparent light-guiding plate. Light emitted from lamp is multiply reflected from one face of light-guiding plate. The reflected light is then transferred to the LCD panel.

The direct illumination type backlight assembly includes a plurality of lamps positioned under the LCD panel, a diffusion plate positioned over lamps, and a reflection plate positioned under lamps. In this type of backlight assembly, light emitted from lamps is reflected from the reflection plate, diffused through a diffusion plate and exits to the LCD panel.

Lamp used in the edge type and the direct illumination type backlight assemblies generally includes a transparent glass gas discharge tube, a fluorescent layer formed inside the glass tube and a pair of electrodes positioned at the ends of the glass tube. The electrodes emit electrons when an external high voltage is applied to the electrodes. The electrons then discharge the discharge gas to generate an ultraviolet ray. The ultraviolet ray is converted into a visible ray by the fluorescent layer. The visible ray is then irradiated from lamp.

With use and age, the fluorescent layer gradually deteriorates and/or the electrodes may become contaminated decreasing luminance and uniformity of lighting. The heat generated by lamp may cause the liquid crystal to deteriorate and also warp the optical member, gradually worsening image display quality.

### SUMMARY OF THE INVENTION

The present invention provides a backlight assembly having an enhanced image display quality by using a light source without a fluorescent material and heat generating electrode. According to one aspect of the present invention, a backlight assembly includes a microwave generating member, a lamp having a luminescent gas excited by microwave and a microwave resonance member surrounding lamp to resonate the microwave.

In an example embodiment of the present invention, light-guiding member may have a bar or plate shape. Light-guiding member may include a plurality of light-incident holes formed in parallel with each other. A pair of light-generating members may be arranged at both ends of the each light-incident hole.

### BRIEF DESCRIPTION OF THE DRAWINGS

The above and other features and advantages of the present invention will become more apparent from a reading of the ensuing description together with the accompanying drawing, in which:

FIG. 1 is an exploded perspective view illustrating a backlight assembly in accordance with an example embodiment of the present invention;

FIG. 2 is a plan view illustrating the backlight assembly in FIG. 1;

FIG. 3 is an enlarged perspective view illustrating a light-generating member of a light-generating unit in FIG. 1;

FIG. 4 is an enlarged perspective view illustrating a light-guiding member of a light-generating unit in FIG. 1;

FIG. 5 is a cross-sectional view taken along a line I-I′ in FIG. 4;

FIGS. 6 and 7 are enlarged perspective views illustrating light-guiding members different from that in FIG. 4;

FIG. 8 is a plan view illustrating a backlight assembly in accordance with an example embodiment of the present invention;

FIG. 9 is an exploded perspective view illustrating a backlight assembly in accordance with an example embodiment of the present invention;

FIG. 10 is a plan view illustrating the backlight assembly in FIG. 9;

FIG. 11 is an enlarged perspective view illustrating a light-guiding member of a light-generating unit in FIG. 9;

FIG. 12 is a plan view illustrating a backlight assembly in accordance with an example embodiment of the present invention;

FIG. 13 is an enlarged perspective view illustrating a light-guiding member of a light-generating unit in FIG. 12;

FIG. 14 is an exploded perspective view illustrating a backlight assembly in accordance with an example embodiment of the present invention; and

FIG. 15 is an exploded perspective view illustrating a display device in accordance with an example embodiment of the present invention.

### DESCRIPTION OF EMBODIMENTS

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

### Embodiment 1

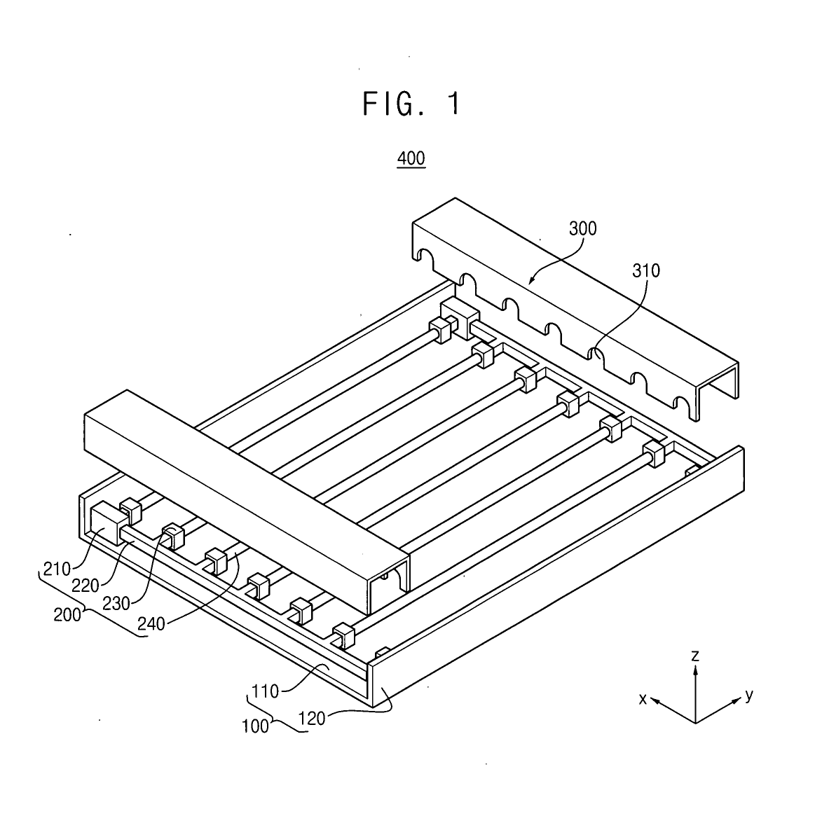

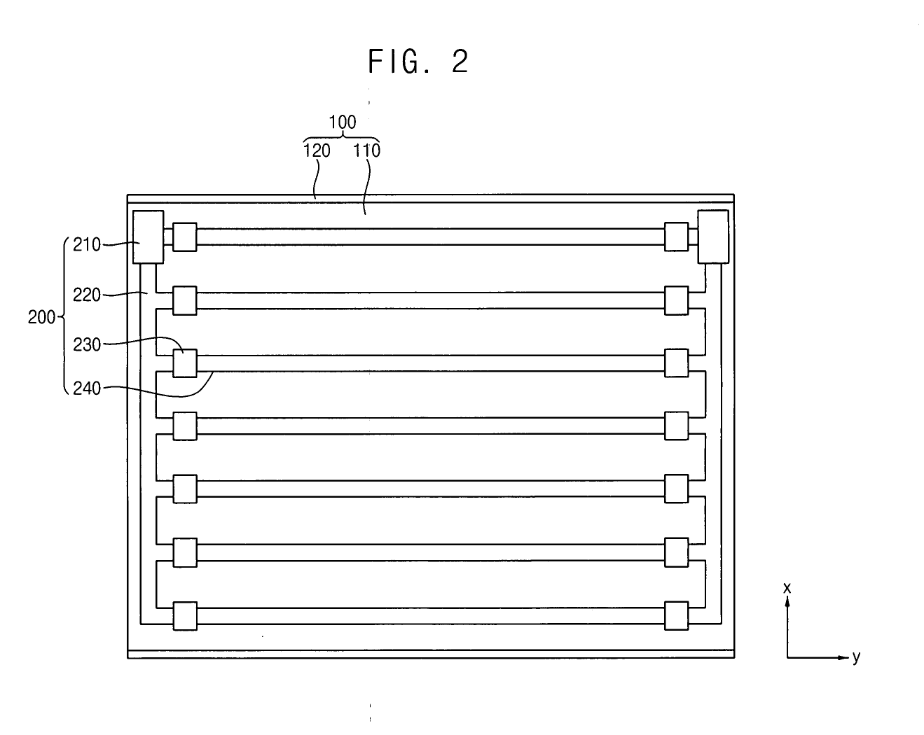

Referring to FIGS. 1 and 2, the backlight assembly 400 of this example embodiment includes a receiving container 100, a light generating unit 200 and a side mold 300. The backlight assembly 400 emits light in a Z-axis direction, that is, an upward direction. Receiving container 100 includes a bottom portion 110 having a plate shape and a side portion 120 extended from an edge of the bottom portion 110. Receiving container 100 may include a metal or a synthetic resin that has good strength and low deformation. Receiving container 100 has a receiving space surrounded by the bottom portion 110 and the side portion 120. Receiving container 100 receives light generating unit 200 and side mold 300.

Side portion 120 of receiving container 100 has only one pair of sidewalls faced with each other along an X-axis direction. Thus, side portion 120 does not include sidewalls faced with each other along a Y-axis direction. In another example embodiment of the present invention, side portion 120 may have two pairs of sidewalls of which the two sidewalls of each pair are faced with each other along the X-axis and Y-axis directions, respectively, although it is not illustrated in FIG. 1.

Light generating unit 200 received in receiving container 100 generates light. Light generating unit 200 includes a microwave generating member 210, a microwave transmitting member 220, a light-generating member 230 and a light-guiding member 240.

Microwave generation member 210 generates a microwave when a power from an external power supply (not shown) is applied. The microwave may have a frequency of about 2 GHz to about 10 GHz, for example, about 2.45 GHz.

A magnetron oscillator may be used as microwave generation member 210. The magnetron generally includes an anode electrode, a cathode electrode facing the anode electrode, and a magnet located substantially perpendicular to the anode electrode and the cathode electrode to generate a strong magnetic field.

While the magnetron generates a microwave, electrons emitted from the cathode electrode are rapidly revolved in the strong magnetic field and then reach to the anode electrode. The electrons enter into a cavity of the anode electrode 110 generate an oscillation current. The oscillation current finally generates the microwave.

A pair of the microwave generating members 210 is arranged at the ends of the bottom portion 110 of receiving container 100 in the Y-axis direction. In other words, a pair of microwave generating members 210 is positioned at each end of the bottom portion 110 at which sidewalls of receiving container 100 are not formed. In another example embodiment of the present invention, microwave generation member 210 may be positioned only at one end of the Y-axis direction although it is not illustrated in FIGS. 1 and 2.

Microwave transmitting member 220 is positioned between microwave generation member 210 and light-generating member 230 and transmits the microwave generated by microwave generation member 210 to light-generating member 230. The microwave transmitting member 220, for example, includes a waveguide capable of transmitting a radio wave. The waveguide may include a metal tube such as a copper tube used for transmitting a microwave. A cross section of the waveguide may have a rectangular or circular shape.

Light-generating member 230 generates light by using a microwave transmitted from the microwave transmitting member 220. A plurality of light-generating members 230 may be arranged on the bottom portion 110 of receiving container 100 in two rows along the X-axis direction. One row of light-generating members 230 may be connected to one of the two microwave generating members 210 through one microwave transmitting member 220 having a plurality of branches, and the other row of light-generating members 230 may be connected to the other microwave generating member 210 through the other microwave transmitting member 220 having a plurality of branches.

In another example embodiment of the present invention, a plurality of light-generating members 230 may be arranged only in one row on the bottom portion 110 of receiving container 100 along the X-axis direction. Thus, light-generating members 230 may be connected to one microwave generating member 2110 through the microwave transmitting member 220 having a plurality of branches, which is not illustrated in FIGS. 1 and 2. That is, one microwave generating member 210 may provide a microwave to the plurality of light-generating members 230. In still another example embodiment of the present invention, more than two microwave generating members 210 may be arranged so that each of the microwave generating members 210 may provide a microwave to the corresponding plural light-generating members 230.

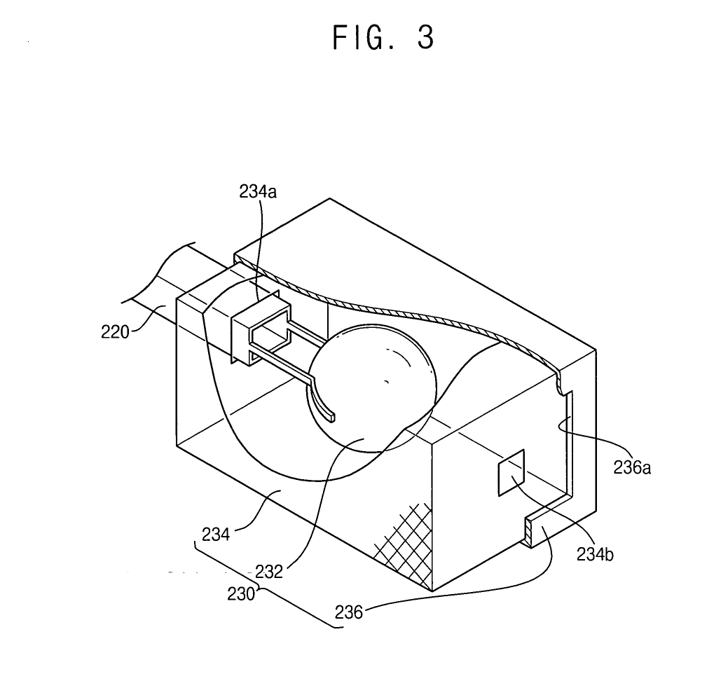

Light-guiding member 240 guides light generated in light-generating members 230 and emits light upwardly from receiving container 100. Light-guiding member 240 may have a bar shape that has a lengthwise direction substantially the same as the Y-axis direction. Light-guiding member 240 is connected to light-generating members 230 that are positioned at both ends of the each light-guiding member 240. A plurality of light-guiding members 240 may be arranged substantially parallel to the X-axis direction. In another example embodiment of the present invention, when light generating members 230 are arranged only in one row, light-guiding member 240 may be connected to light-generating members 230 positioned at one end of light-guiding member 240. Light generating member 230 and light-guiding member 240 will be fully described with reference to FIGS. 3 to 7.

Side mold 300 covers microwave generation member 210, the microwave transmitting member 220 and light-generating member 230. Side mold 300 is positioned on both ends of the bottom portion 110 of receiving container 100 at which sidewalls of receiving container 100 are not formed. Thus, side mold 300 may function as sidewalls of receiving container 100. In addition, an optical member (not shown) may be formed on side mold 300 to enhance optical characteristics of light generating unit 200. A cross section of side mold 300 may have a right-angled U shape. When receiving container 100 alternatively includes four sidewalls along the X-axis and the Y-axis directions, side mold 300 may have an L shape.

In another example embodiment of the present invention, the backlight assembly 400 may further include a guide-supporting member (not shown) for supporting light-guiding member 240 and a reflecting plate (not shown) positioned under light generating unit 200, although these are not illustrated in FIG. 1. The guide-supporting member may support light-guiding member 240 to prevent a center portion of light-guiding member 240 from being subsided. The reflecting plate may be positioned on the bottom portion 110 of receiving container 100 to reflect light generated in light generating unit 200 upwardly from receiving container 100.

FIG. 3 is an enlarged perspective view illustrating light-generating member 230 of light generating unit 200 in FIG. 1. Light-generating member 230 includes a lamp 232, a microwave resonance member 234 and a light-reflecting member 236. Lamp 232 generates light by using a microwave transmitted from the microwave transmitting member 210. For example, lamp 232 may be a transparent spherical tube. Lamp 232 includes a luminescent gas in the transparent tube. An inactive gas may be advantageously used as the luminescent gas. Examples of the inactive gas may include a sulfur (S) gas, an argon (Ar) gas, a krypton (Kr) gas, etc. Lamp 232 may be fixed to the microwave transmitting member 220.

When a microwave transmitted from the microwave transmitting member 220 meets the luminescent gas in lamp 232, the luminescent gas is excited and is then converted into an ionized plasma state to generate light.

Microwave resonance member 234 surrounds lamp 232 to resonate the microwave transmitted from microwave transmitting member 220. That is, microwave resonance member 234 resonates the microwave to prevent the microwave from out flowing to the exterior of microwave resonance member 234. As a result, lamp 232 may emit a large amount of light by using the resonating microwave in the microwaver resonance member 234.

Microwave resonance member 234 may advantageously include a metal providing a resonance effect. In addition, microwave resonance member 234 may advantageously have a mesh structure that allows light emitted from lamp 232 to be emitted. When the meshes of microwave resonance member 234 are excessively dense, the amount of the effect may increase but less light will be emitted from lamp 323. Thus, microwave resonance member 234 may advantageously have a mesh structure that provides optimal density.

Microwave resonance member 234 includes a microwave incident hole 234a and a microwave-exit hole 234b. The microwave incident hole 234a is connected to an end of the microwave transmitting member 220. The microwave enters microwave resonance member 234 through the microwave incident hole 234a.

Microwave exit hole 234b is positioned on an opposite side of microwave incident hole 234a. A portion of the microwave may exit through microwave exit hole 234b. Microwave exit hole 234b may advantageously have an area substantially smaller than that of microwave incident hole 234a to reduce the amount of exiting microwave. Microwave exit hole 234b may mainly serve as to enhance a transmission rate of light emitted from lamp 232.

Although the mesh structure of microwave resonance member 234 is partially illustrated in FIG. 3, all portion of microwave resonance member 234 may have a mesh structure except for the microwave incident hole 234a and the microwave exit hole 234b.

Light-reflecting member 236 partially surrounds microwave resonance member 234 and reflects light emitted from lamp 232 toward light-guiding member 240. Light-reflecting member 236 includes a light-exiting hole 236a. Light reflected by light-reflecting member 236 may pass through light-exiting hole 236a and proceed toward light-guiding member 240. Light-exiting hole 236a is positioned over the microwave exit hole 234b. Light-exiting hole 236a may have an area substantially greater than that: of the microwave exit hole 234b. Light-exiting hole 236a is connected to light-guiding member 240. Light-exiting hole 236b may provide a pathway of the reflected light to light-guiding member 240.

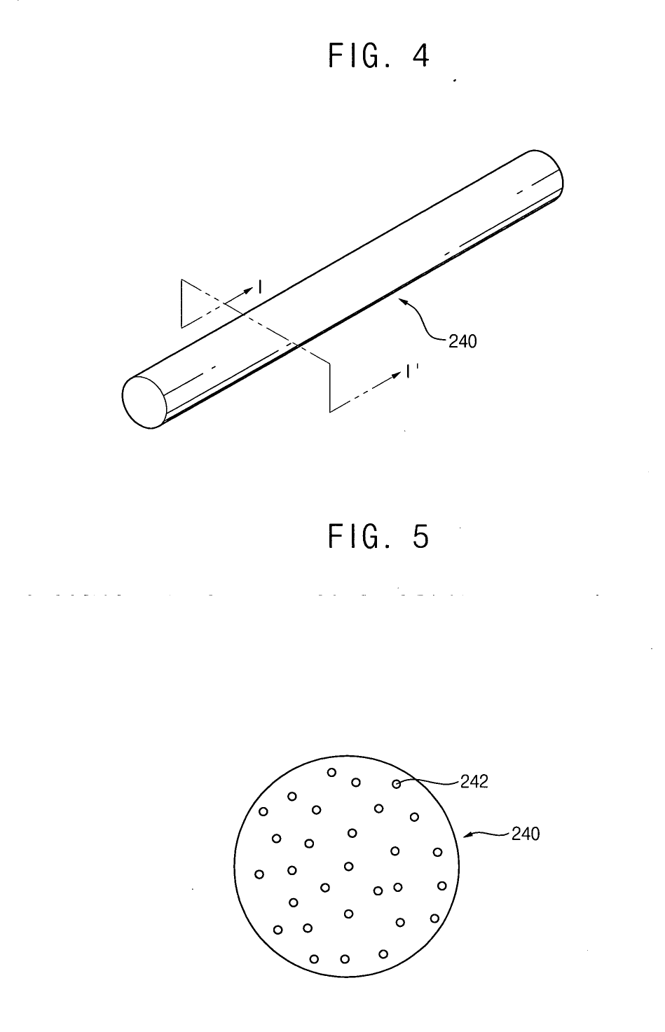

Referring to FIGS. 4 and 5, light-guiding member 240 has a bar shape with an elliptical cross section. For example, light-guiding member has a bar shape with a circular cross section. Light-guiding member 240 may be an optical pipe, an optical fiber, a light guide plate, etc. Light-guiding member 240 may include glass or a synthetic resin. An example of the synthetic resin may include poly methyl methacrylate (PMMA).

Light-guiding member 240 is connected to light-generating member 230. Light-guiding member 240 may receive light emitted from light-generating member 230 and guide light upwardly from receiving container 100. A light-diffusion material 242 is distributed in light-guiding member 240 to enhance a light diffusion efficiency. In one example embodiment of the present invention, light-diffusion material 242 may have a beady shape irregularly distributed in light-guiding member 240. In another example embodiment of the present invention, air bubbles used as light diffusion material 242 may be irregularly distributed in light-guiding member 240.

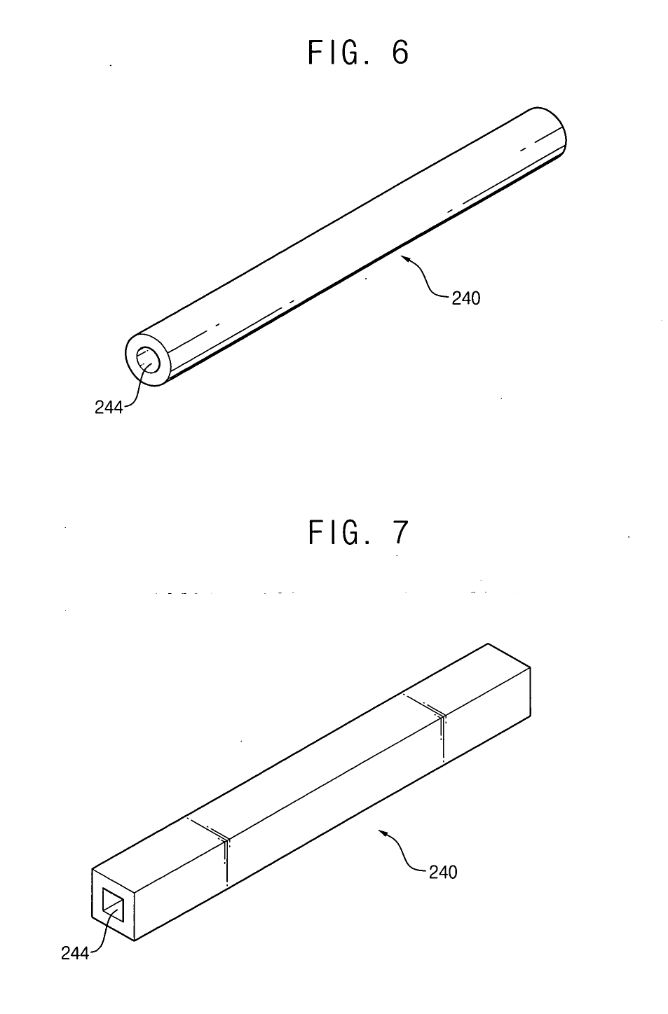

Referring to FIG. 6, light-guiding member 240 may further include a light-transmitting hole 244 formed along a lengthwise direction of light-guiding member 240. Light-transmitting hole 244 may be advantageously positioned at a cross-sectional center along a lengthwise direction of light-guiding member 240. A cross section of light-transmitting hole 244 may have an elliptical shape substantially similar to that of light-guiding member 240. Light-transmitting hole 244 may enhance a light transmission efficiency generated from light-generating member 230.

Referring to FIG. 7, light-guiding member 240 may have a bar shape with a polygonal cross section. For example, light-guiding member 240 may have a bar shape with a rectangular cross section. In addition, light-guiding member 240 may include a light-transmitting hole 244 having a polygonal cross section such as a rectangular cross section. When light-guiding member 240 has a bar shape with a rectangular cross section, a plurality of light-guiding members 240 may be closely arranged in receiving container 100.

According to this example embodiment, light generating unit 200 may generate light by using a microwave instead of an electrode and a fluorescent material. Therefore, light-generating unit may prevent a large amount of heat from being generated. Further, light-generating unit may have a long life span. Furthermore, light generating unit 200 may generate a light having enhanced a luminance uniformity and a stability.

### Embodiment 2

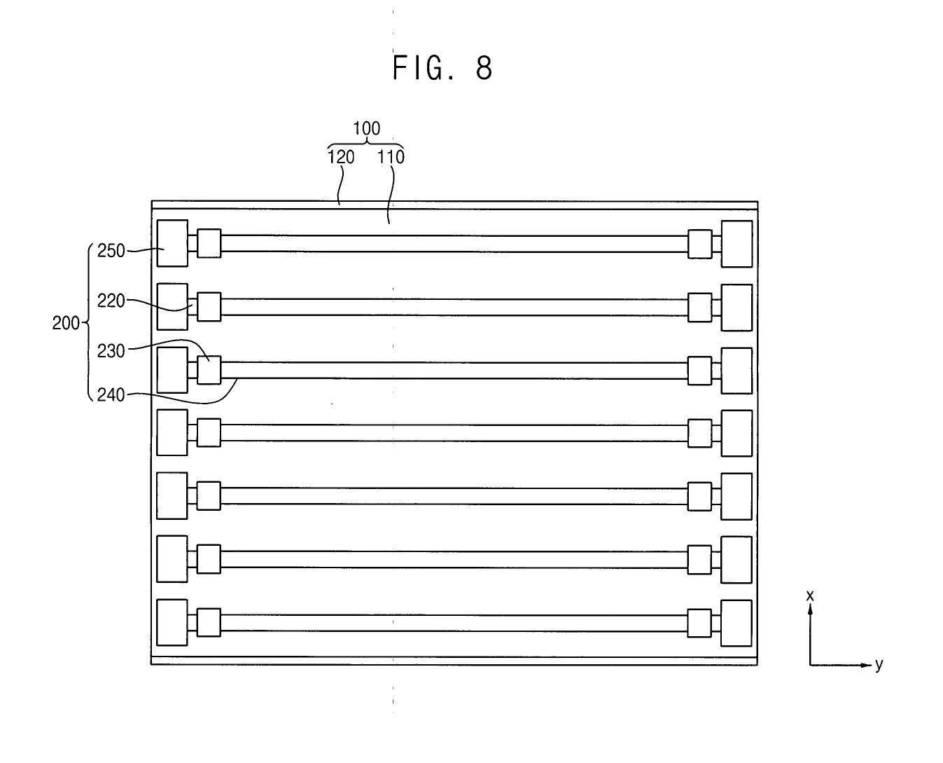

FIG. 8 is a plan view illustrating a backlight assembly in accordance with another example embodiment of the present invention. The backlight assembly of this example embodiment includes elements substantially the same as those of the backlight assembly described with reference to FIG. 2 except for a light-generating unit 200. Thus, same reference numerals refer to the same elements and any further illustrations with respect to the same elements will be omitted herein for brevity.

Referring to FIG. 8, light generating unit 200 positioned in receiving container 100 generates light. Light generating unit 200 includes a microwave generating member 250, a microwave transmitting member 220, a light-generating member 230 and a light-guiding member 240.

Microwave generating member 250 generates a microwave when a power from an external power supply (not shown) is applied. The microwave may have a frequency of about 2 GHz to about 10 GHz, for example, about 2.45 GHz.

A plurality of the microwave generating members 250 is arranged on both ends of the bottom portion 110 of receiving container 100 in the Y-axis direction. In other words, a plurality of the microwave generating members 250 is positioned on both ends of the bottom portion 110 at which sidewalls of receiving container 100 are not formed. The microwave generating members 250 are arranged in a row along the X-axis direction.

Microwave transmitting member 220 is positioned between the microwave generating member 250 and light-generating member 230. Microwave transmitting member 220 connects the microwave generating member 250 to light-generating member 230, and transmits a microwave generated from microwave generating member 250 to light-generating member 230.

Light-generating member 230 generates light by using the microwave transmitted by microwave transmitting member 220. A plurality of light-generating members 230 may be arranged on the bottom portion 110 of receiving container 100 in two rows along the X-axis direction.

Light-guiding member 240 guides light generated from light-generating members 230 and emits light in the Z-axis direction, that is, an upward direction of receiving container 100. Light-guiding member 240 may have a bar shape that has a lengthwise direction substantially the same as the Y-axis direction. Light-guiding member 240 is connected to light-generating members 230 that are positioned at both ends of light-guiding member 240. A plurality of light-guiding members 240 may be arranged substantially parallel to the X-axis direction.

According to this embodiment, light generating unit 200 includes a pair of the microwave generating members 250, a pair of the microwave transmitting members 220 and a pair of light-generating members 230, which are positioned at both ends of each light-guiding member 240 to operate each light-guiding member 240. In another example embodiment of the present invention, light generating unit 200 may include one microwave generating member 250, one microwave transmitting member 220 and one light-generating member 230, which are positioned at one end of light-guiding member 240, although it is not illustrated in FIG. 8.

### Embodiment 3

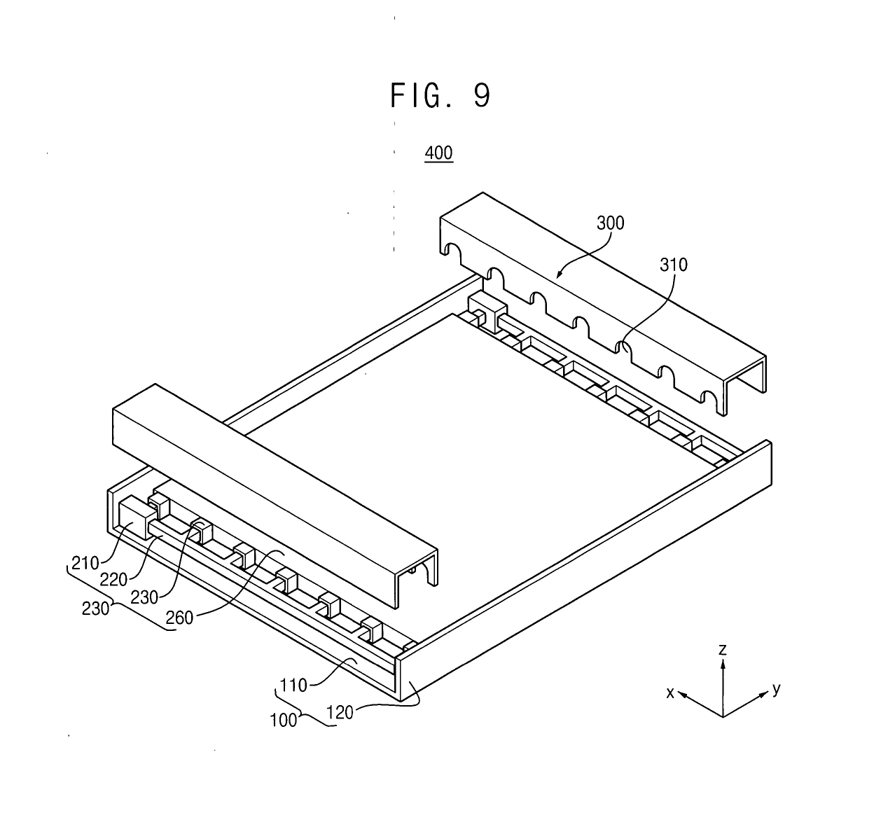

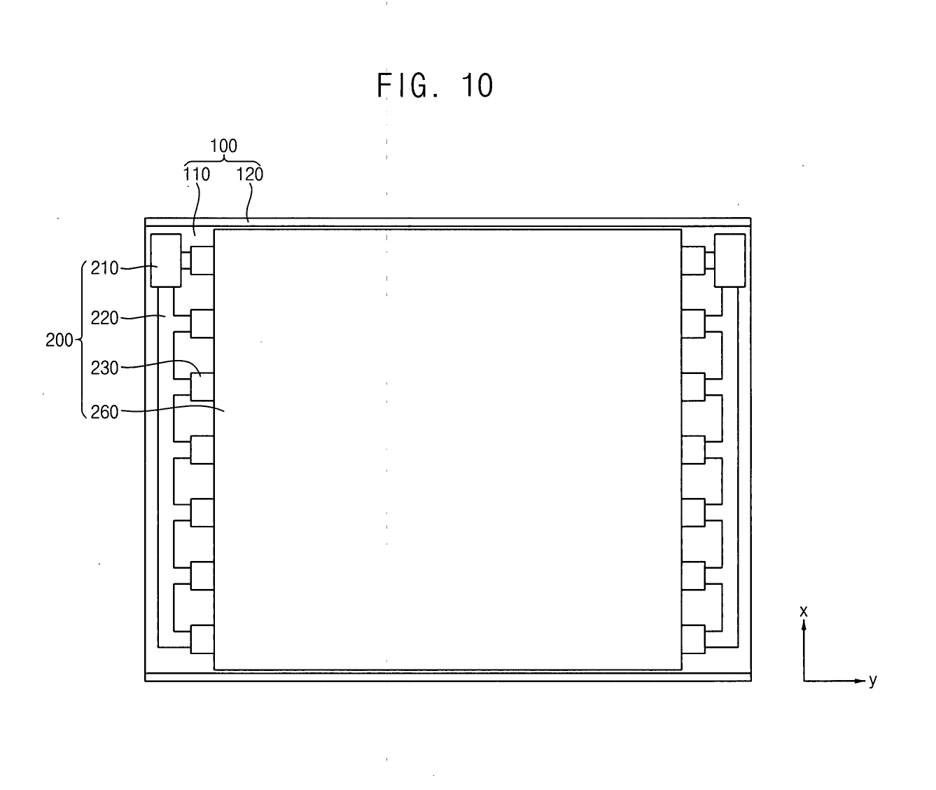

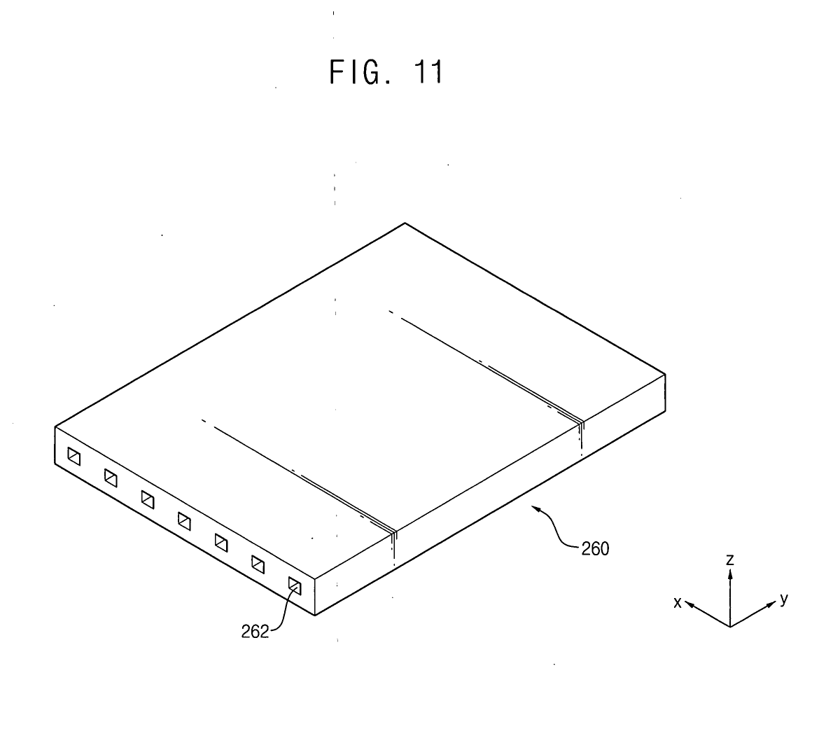

FIG. 9 is an exploded perspective view illustrating a backlight assembly in accordance with still another example embodiment of the present invention. FIG. 10 is a plan view illustrating the backlight assembly in FIG. 9. The backlight assembly of this embodiment includes elements substantially the same as those of the backlight assembly described with reference to FIGS. 1 and 2 except for a light-generating unit 200. Thus, same reference numerals refer to the same elements and any further explanations with respect to the same elements will be omitted herein for brevity.

Referring to FIGS. 9 and 10, light generating unit 200 received in a receiving container 100 generates light. Light generating unit 200 includes a microwave generating member 210, a microwave transmitting member 220, a light-generating member 230 and a light-guiding member 260.

Microwave generation member 210 generates a microwave when a power from an external power supply (not shown) is applied. The microwave may have a frequency of about 2 GHz to about 110 GHz, for example, about 2.45 GHz.

A pair of microwave generating members 210 is arranged on both ends of the bottom portion 110 of receiving container 100 in the Y-axis direction. In other words, a plurality of the microwave generating members 210 is positioned on both ends of the bottom portion 110 at which sidewalls of receiving container 100 are not formed.

Microwave transmitting member 220 is positioned between microwave generation member 210 and light-generating member 230. Microwave transmitting member 220 connects microwave generation member 210 to light-generating member 230, and transmits a microwave generated from microwave generation member 210 to light-generating member 230.

Light-generating member 230 generates light by using a microwave transmitted from the microwave transmitting member 220. A plurality of light-generating members 230 may be arranged on the bottom portion 110 of receiving container 100 in two rows along the X-axis direction. One row of light-generating members 230 may be connected to one of the two microwave generating members 210 through one microwave transmitting member 220 having a plurality of branches, and the other row of light-generating members 230 may be connected to the other microwave generating member 210 through the other microwave transmitting member 220 having a plurality of branches.

FIG. 11 is an enlarged perspective view illustrating light-guiding member 260 of light generating unit 200 in FIG. 9. Referring to FIG. 11, light-guiding member 260 guides light generated from light-generating members 230 and emits light upwardly from receiving container 100. In other words, light generated from light-generating members 230 may be entirely reflected by light-guiding member 260 and then emitted to an upward direction of receiving container 100.

Light-guiding member 260 may have a rectangular plate, and have a predetermined thickness. Light-guiding member 240 is positioned on the bottom portion 110 of receiving container 100. A light diffusion material such as a bead or an air bubble may be irregularly distributed in light-guiding member 260.

Light-guiding member 260 includes a plurality of light-incident holes 262 formed in parallel. Light-incident holes 262 may be lengthwise in the Y-axis direction. Light-generating members 230 are arranged at both ends of the each light-incident hole 262. Light generated from light-generating members 230 may enter light-guiding member 260 through light-incident holes 262. Light-incident holes 262 may have, for example, a rectangular cross section.

### Embodiment 4

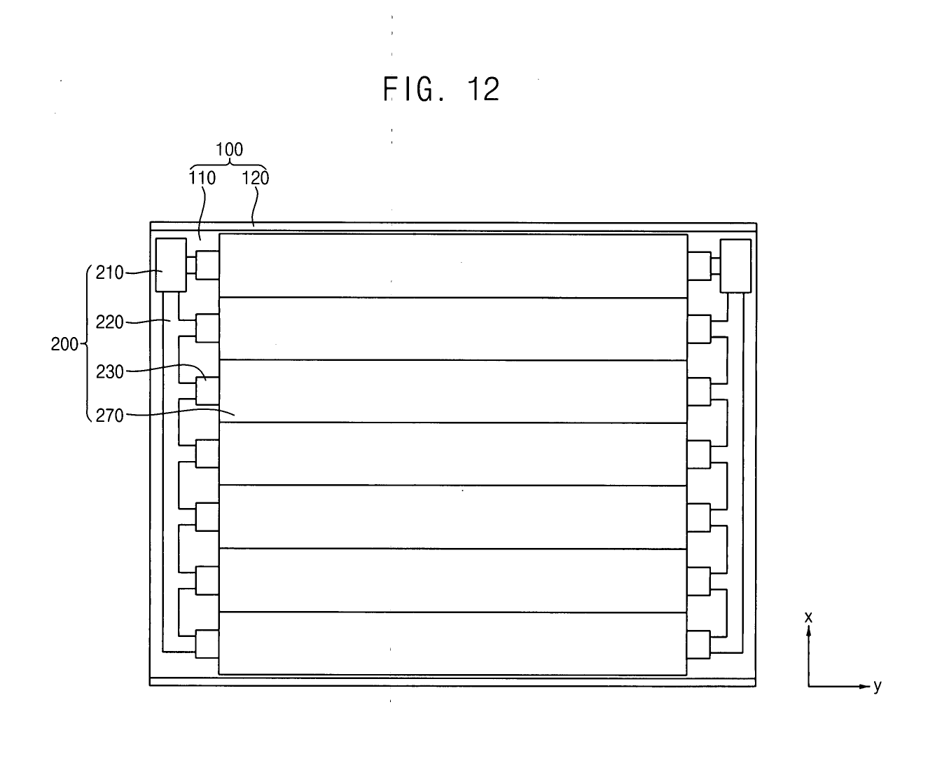

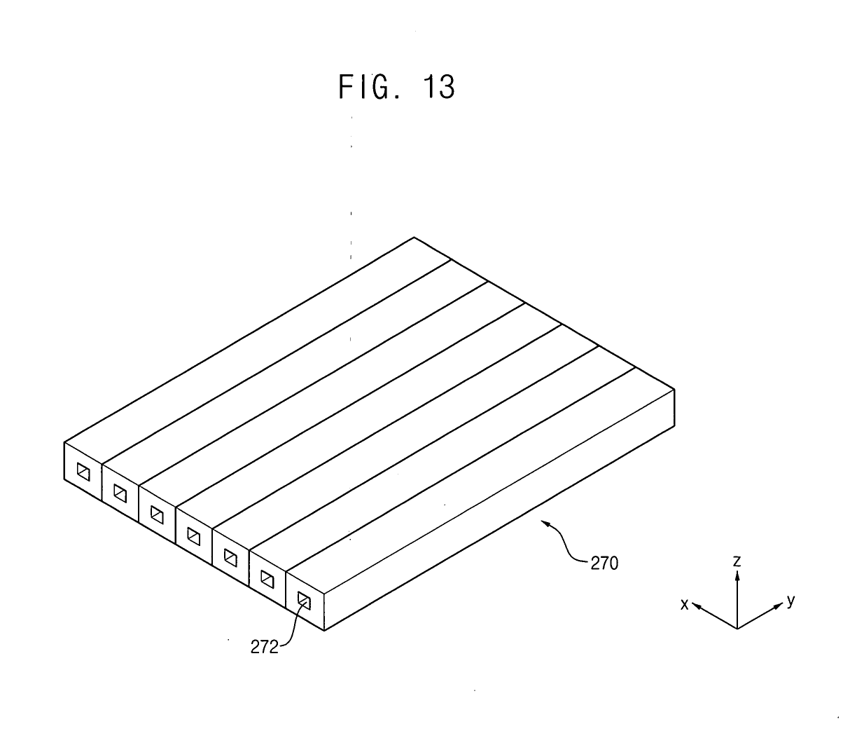

FIG. 12 is a plan view illustrating a backlight assembly in accordance with still another example embodiment of the present invention. FIG. 13 is an enlarged perspective view illustrating a light-guiding member 270 of a light-generating unit 200 in FIG. 12. The backlight assembly of this embodiment includes elements substantially the same as those of the backlight assembly described with reference to FIGS. 1 and 2 except for light generating unit 200. Thus, the same reference numerals refer to the same elements, and any further explanations regarding the same elements will be omitted herein for brevity.

Referring to FIGS. 12 and 13, light generating unit 200 received in receiving container 100 generates light. Light generating unit 200 includes a microwave generating member 210, a microwave transmitting member 220, a light-generating member 230 and a light-guiding member 270.

Microwave generation member 210 generates a microwave when a power from an external power supply (not shown) is applied. The microwave may have a frequency of about 2 GHz to about 10 GHz, for example, about 2.45 GHz.

A pair of microwave generating members 210 is arranged on both ends of the bottom portion 110 of receiving container 100 in the Y-axis direction. In other words, a plurality of the microwave generating members 210 is positioned on both ends of the bottom portion 110 at which sidewalls of receiving container 100 are not formed.

Microwave transmitting member 220 is positioned between microwave generation member 210 and light-generating member 230. The microwave transmitting member 220 connects microwave generation member 210 to light-generating member 230, and transmits a microwave generated from microwave generation member 210 to light-generating member 230.

Light-generating member 230 generates light by using a microwave transmitted from the microwave transmitting member 220. A plurality of light-generating members 230 may be arranged on the bottom portion 110 of receiving container 100 in two rows along the X-axis direction. One row of light-generating members 230 may be connected to one of the two microwave generating members 210 through one microwave transmitting member 220 having a plurality of branches, and the other row of light-generating members 230 may be connected to the other microwave generating member 210 through the other microwave transmitting member 220 having a plurality of branches.

Light-guiding member 270 guides light generated from light-generating members 230 and then emits light upwardly from receiving container 100. In other words, light generated from light-generating members 230 may be entirely reflected by light-guiding member 270 and then emitted to an upward direction of receiving container 100.

Light-guiding member 270 may have a bar shape that is lengthwise in the Y-axis direction. Light-guiding member 270 may have a rectangular cross section. A plurality of light-guiding members 270 may be arranged substantially parallel to the X-axis direction. The plurality of light-guiding members 240 may be closely arranged with each other in receiving container 100.

A light diffusion material such as a bead or an air bubble may be irregularly distributed in light-guiding member 270.

Each of light-guiding members 270 includes a light-incident hole 272 that is lengthwise in the Y-axis direction. Light-generating members 230 are arranged at both ends of light-incident hole 272. Light generated from light-generating members 230 may enter light-guiding member 270 through light-incident hole 272. Light-incident hole 272 may have a rectangular cross section.

### Embodiment 5

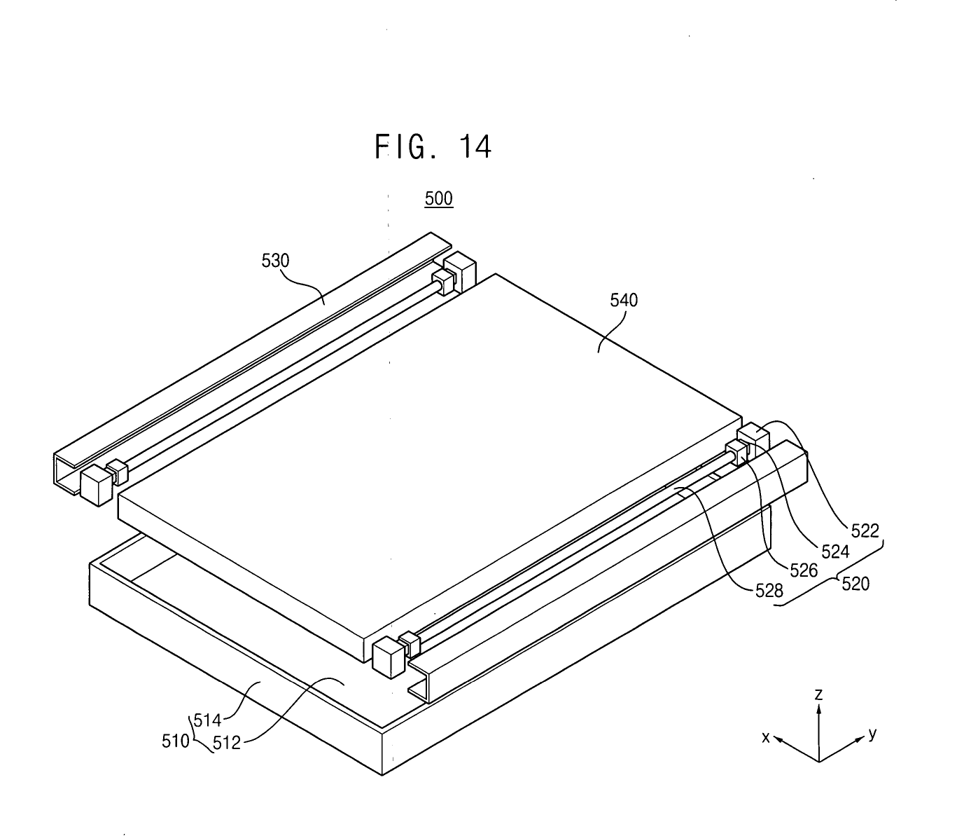

FIG. 14 is an exploded perspective view illustrating a backlight assembly in accordance with still another example embodiment of the present invention. Referring to FIG. 14, the backlight assembly includes a receiving container 510, a light-generating unit 520, a lamp cover 530 and a light-guiding plate 540.

Receiving container 510 includes a bottom portion 512 and a side portion 514 that define a receiving space. Receiving container 510 receives light-generating unit 520, lamp cover 530 and light-guiding plate 540.

Light-generating unit 520 positioned in receiving container 510 generates light. A pair of light-generating units 520 that lengthwise along a Y-axis direction may be arranged on both ends of the bottom portion 512 of receiving container 510 in an X-axis direction. In another example embodiment of the present invention, one light-generating unit 520 may be arranged on only one end of the bottom portion 512 of receiving container 510 in the X-axis direction, although it is not illustrated in FIG. 14.

Light-generating unit 520 includes a microwave generating member 522, a microwave transmitting member 524, a light-generating member 526 and a light-guiding member 528.

The microwave generating member 522 generates a microwave when a power from an external power supply is applied. Microwave transmitting member 524 connects microwave generating member 522 to light-generating member 526, and transmits a microwave from the microwave generating member 522 to light-generating member 526. The microwave generating member 526 generates light by using the transmitted microwave. Light-guiding member 528 guides light generated from light-generating member 526, and then emits light upwardly from receiving container 510.

A pair of the microwave generating members 522, a pair of the microwave transmitting members 524 and a pair of light-generating members 526 may be arranged at both ends of light-guiding member 528 as illustrated in FIG. 14. In another example embodiment of the present invention, one microwave generating member 522, one microwave transmitting member 524 and one light-generating member 526 may be arranged only at one end of light-guiding member 528.

Lamp cover 530 partially surrounds light-generating unit 520 and reflects light generated from light-generating unit 520 toward a side face of light-guiding plate 540. For example, lamp cover 530 may have a U shape.

Light-guiding plate 540 is positioned on the bottom portion 512 of receiving container 510. Light-guiding plate 540 guides light incident through the side face and emits light through an upper face of light-guiding plate 540.

The backlight assembly may further include a reflection plate (not shown) positioned under light-guiding plate 540. The reflection plate may reflect light emitted from a bottom face of light-guiding plate 540 toward the upper face of light-guiding plate 540.

### Embodiment 6

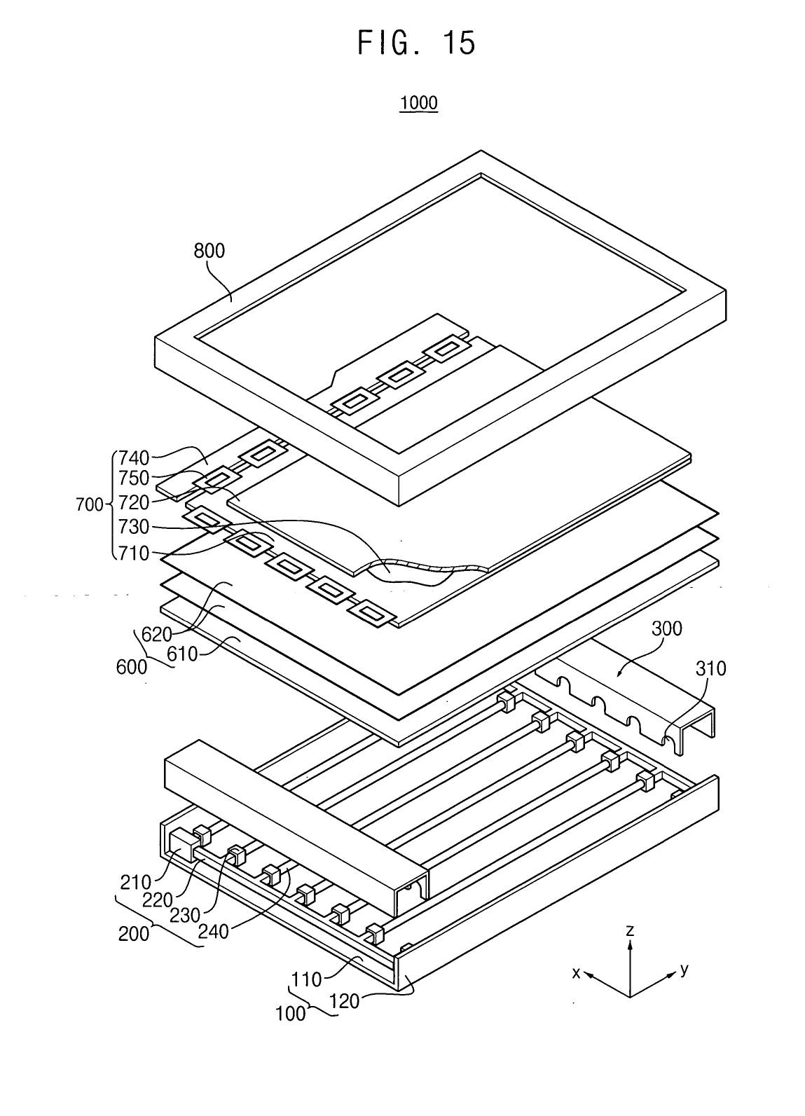

FIG. 15 is an exploded perspective view illustrating a display device in accordance with an example embodiment of the present invention. A backlight assembly included in the display device includes elements substantially the same as those of the backlight assembly described with reference to FIGS. 1 and 2. Thus, the same reference numerals referring to the same elements and any further explanations regarding the same elements will be omitted herein for brevity.

Referring to FIG. 15, the display device 1000 includes a backlight assembly, an optical member 600, a display panel 700 and a top chassis 800. The display device 1000 displays an image using light. The backlight assembly is positioned under the display panel 700. The backlight assembly includes a receiving container 100, a light-generating unit 200 and a side mold 300. The backlight assembly provides light to the display panel 700.

Optical member 600 is arranged between the display panel 700 and the backlight assembly. Optical member 600 is positioned on side mold 300 of the backlight assembly. Optical member 600 may enhance optical characteristics of light generated from the backlight assembly. For example, optical member 600 may include a diffusion plate 610 and at least one prism sheet 620.

Diffusion plate 610 diffuses light emitted from the backlight assembly and enhances the luminance uniformity of light. For example, a pair of the prism sheets 620, which are substantially parallel to each other may be arranged on the diffusion plate 610. A pair of the prism sheets 620 may reflect and refract light that goes through the diffusion plate 610. The prism sheet 620 may enhance a front luminance of light.

Display panel 700 is positioned on the optical member 600. The display panel 700 may transform light passing through the optical member 600 into an image light having data. The display panel 700 includes a thin film transistor (TFT) substrate 710, a color filter substrate 720, a liquid crystal layer 730, a printed circuit board (PCB) 740 and a flexible PCB 750.

TFT substrate 710 includes a plurality of pixel electrodes, TFTs and signal lines. The pixel electrodes may be arranged in a matrix pattern. Each of the TFTs may apply a driving voltage to each of the pixel electrodes. The signal lines may serve as to operate the TFTs.

Pixel electrodes may be formed by patterning a transparent and conductive thin film through a photolithography process. The thin film may be formed using indium tin oxide (ITO), indium zinc oxide (IZO) or amorphous indium tin oxide (a-ITO).

Color filter substrate 720 is arranged to face the TFT substrate 710. The color filter substrate 720 includes a common electrode and color filters. The common electrode may be positioned on an entire face of the color filter substrate 720. The common electrode may include a transparent and conductive material. The color filters may face the pixel electrodes.

The color filters include a red color filter selectively transmitting only a red light out of a white light, a green color filter selectively transmitting a green light, and a blue color filter selectively transmitting a blue light.

A liquid crystal layer 730 is interposed between the TFT substrate 710 and the color filter substrate 720. Liquid crystal molecules in the liquid crystal layer 730 may be rearranged by an electric field formed between the pixel electrode and the common electrode. The rearranged liquid crystal molecules may change a transmissivity of light passing through the optical member 600. Light having changed transmissivity may pass through the color filters to display an image having a desired gradation.

The PCB 740 includes a driving circuit unit for processing an image signal. The driving circuit unit may transform an external image signal into a driving signal for controlling the TFT.

The PCB 740 may include a data PCB and a gate PCB. The data PCB bent by the flexible PCB 750 may be positioned on a side or a bottom face of receiving container 100. The gate PCB bent by the flexible PCB 750 may be positioned on a side or a bottom face of receiving container 100. Alternatively, when additional signal lines are formed on the TFT substrate 710 and the flexible PCB 750, the gate PCB may be omitted as illustrated in FIG. 15.

The flexible PCB 750 may electrically connect the PCB 740 to the TFT substrate 710 and supply a driving signal generated from the PCB 740 to the TFT substrate 710. The flexible PCB 750 may be, for example, a tape carrier package (TCP) or a chip on film (COF).

The top chassis 800 covering an edge of the display panel 700 is combined with the side portion 120 of receiving container 100 to fix the display panel 700 over the backlight assembly.

The top chassis 800 may protect the display panel 700 having a high brittleness from being damaged by an external shock or vibration and prevent the detachment of the display panel 700 from receiving container 100.

The display device 1000 may further include a panel-fixing member (not shown). The panel-fixing member positioned between the optical member 600 and the display panel 700 may fix the optical member 600 and support the display panel 700.

According to the present invention, light-generating unit may generate light by using a microwave in place of an electrode and a fluorescent material to prevent a large amount of heat from being generated, so that a deterioration of a liquid crystal layer and a deformation of light-generating unit may be avoided.

In addition, light-generating unit may generate a visible light similar to a natural light by using a microwave so that a display device may have enhanced color reproducibility.

Light-generating unit may have a semi-permanent life span by generating light with a microwave so that a replacing cost of light-generating unit may be greatly reduced. Luminance variations with passage of the time may be prevented, and a light generation efficiency may be enhanced. As a result, light-generating unit may have enhanced luminance uniformity and stability by generating light with a microwave instead of an electrode and a fluorescent material so that the display device may have an improved image display quality.

The foregoing is deemed to be illustrative of the principles of the present invention. Numerous changes and modifications will be apparent to those skilled in the art and may be made without, however, departing from the spirit and scope of the invention.

What is claimed is:

1. A backlight assembly for a display comprising:
a microwave generating member generating a microwave;
a light-generating member generating light using the microwave; and
a light-guiding member connected to the light-generating member, the light-guiding member guiding the light generated from the light-generating member.

2. The backlight assembly of claim 1, wherein the microwave generating member comprises a magnetron.

3. The backlight assembly of claim 1, further comprising a microwave transmitting member connecting the microwave generating member to the light-generating member, the microwave transmitting member transmitting the microwave to the light-generating member.

4. The backlight assembly of claim 3, wherein the microwave transmitting member comprises a waveguide.

5. The backlight assembly of claim 1, wherein the light-generating member comprises:
a lamp including a luminescent gas excited by the microwave to emit light; and
a microwave resonance member surrounding the lamp to resonate the microwave.

6. The backlight assembly of claim 5, wherein the microwave resonance member has a mesh structure.

7. The backlight assembly of claim 5, wherein the microwave resonance member comprises a metal.

8. The backlight assembly of claim 5, wherein the light-generating member further comprises a light-reflecting member partially surrounding the microwave resonance member and reflecting the light emitted from the lamp toward the light-guiding member.

9. The backlight assembly of claim 1, wherein the light-guiding member has a bar shape.

10. The backlight assembly of claim 9, wherein the light-guiding member has a circular cross section.

11. The backlight assembly of claim 9, wherein the light-guiding member has a rectangular cross section.

12. The backlight assembly of claim 9, wherein beads diffusing light are distributed in the light-guiding member.

13. The backlight assembly of claim 9, wherein air bubbles diffusing light are distributed in the light-guiding member.

14. The backlight assembly if claim 9, wherein the light-guiding member comprises a light-transmitting hole formed in a lengthwise direction of the light-guiding member.

15. The backlight assembly of claim 9, wherein a pair of the light-generating members is arranged at the ends of the light-guiding member.

16. The backlight assembly of claim 9, wherein a plurality of the light-guiding members are arranged in parallel with each other.

17. The backlight assembly of claim 16, wherein a plurality of the light-generating members arranged at one end of the light-guiding members generate light by using the microwave generated from one microwave generating member.

18. The backlight assembly of claim 17, further comprising a microwave transmitting member positioned between the microwave generating member and a plurality of the light-generating members, the microwave transmitting member having a plurality of branches that transmit the microwave to each of the light-generating members.

19. The backlight assembly of claim 1, wherein the light-guiding member has a plate shape.

20. The backlight assembly of claim 19, wherein the light-guiding member has a plurality of light-incident holes formed in parallel with each other.

21. The backlight assembly of claim 20, wherein a pair of the light-generating members is arranged at the ends of the each light-incident hole.

22. The backlight assembly of claim 1, wherein the microwave has a frequency of about 2 GHz to about 10 GHz.

23. A display device comprising:
a backlight assembly including a receiving container having a bottom portion and a side portion, and a light-generating unit received in the receiving container to generate light by using a microwave; and
a display panel positioned over the backlight assembly, the display panel displaying an image by using the light generated from the light-generating unit.

24. The display device of claim 23, wherein light-generating unit comprises:
a microwave generating member generating a microwave;
a light-generating member generating light by using the microwave; and
a light-guiding member connected to the light-generating member for guiding the light generated bad the light-generating member.
